(19) United States
(12) Patent Application Publication
(10) Pub. No.: US 2014/0147679 A1
(43) Pub. Date: May 29, 2014

(54) SHEET OF FLOAT GLASS HAVING HIGH ENERGY TRANSMISSION

(71) Applicants: Audrey Dogimont, Jumet (BE); Nicolas Fedullo, Jumet (BE); Sebastien Hennecker, Jumet (BE)

(72) Inventors: Audrey Dogimont, Jumet (BE); Nicolas Fedullo, Jumet (BE); Sebastien Hennecker, Jumet (BE)

(73) Assignee: AGC Glass Europe, Bruxelles (Watermael-Boitsfort) (BE)

(21) Appl. No.: 14/130,810

(22) PCT Filed: Jun. 15, 2012
(86) PCT No.: PCT/EP12/61418

§ 371 Date: Jan. 3, 2014

(30) Foreign Application Priority Data
Jul. 4, 2011 (BE) BE 2011/0416

(51) Int. Cl. C03C 3/085

(52) U.S. Cl. CPC C03C 3/085
USPC 428/426; 501/69

(57) ABSTRACT

The invention relates to a sheet of extra-clear glass, that is to say a sheet of glass having high energy transmission, which can be used in particular in the field of solar energy. More specifically, the invention relates to a sheet of float glass having a composition which comprises, in a content expressed as percentages of the total weight of glass: SiO₂ 60-75%; Al₂O₃: 0-10%; B₂O₃: 0-5%; CaO: 0-15%; MgO: 0-10%; Na₂O: 5-20%; K₂O: 0-10%; BaO: 0-5%; total iron (expressed as Fe₂O₃): 0.001 to 0.06%; antimony (expressed as Sb₂O₃): 0.02 to 0.07%.

### 1. FIELD OF THE INVENTION

The field of the invention is that of glasses with a high energy transmission that are usable in particular in photovoltaic modules or solar mirrors. More specifically, the invention relates to such a glass sheet that is formed by the float process that consists of pouring the molten glass onto a molten tin bath in reductive conditions, and is also referred to as a sheet of float glass.

In the field of solar technology where glass is used as a substrate for solar mirrors or to cover photovoltaic cells, it is of course extremely advantageous when the glass used, through which the rays of the sun must pass, has a very high visible and/or energy transmission. The efficiency of a solar cell is in fact significantly improved by even a very small increase in this transmission. In particular, a visible and/or energy transmission higher than 89%, preferably higher than 90% or even higher than 91% is highly desirable.

To quantify the transmission of the glass in the range encompassing the visible and the solar infrared (or near infrared) an energy transmission (ET) is defined that is measured according to standard ISO 9050 between wavelengths 300 and 2500 nm. In the present description as well as in the claims the energy transmission is measured according to this standard and given for a thickness of 4 mm (ET4).

To quantify the transmission of the glass in the visible range, a light transmission (LT) is defined that is calculated between wavelengths 380 and 780 nm according to standard ISO 9050 and measured with illuminant D65 (LTD), as defined by standard ISO/CIE 10526 with consideration of the CIE 1931 colorimetric reference observer as defined in standard ISO/CIE 10527. In the present description as well as in the claims the light transmission is measured in accordance with this standard and given for a thickness of 4 mm (LTD4) at a solid observation angle of 2°.

### 2. PRIOR ART

To obtain LT and/or ET values higher than 89%, or even higher than 90%, it is known in the prior art to reduce the total content of iron in the glass (expressed in terms of Fe₂O₃ according to standard practice in the field). So-called “clear” or “extra clear” soda-lime-silica glasses always contain iron, because this is present as an impurity in the majority of the raw materials used (sand, lime, dolomite . . . ). Iron exists in the structure of the glass in the form of ferric ions Fe³⁺ and ferrous ions Fe²⁺. The presence of ferric ions Fe³⁺ gives the glass a low absorption for visible light of low wavelength and a high absorption in the near ultraviolet (broad absorption band centred on 380 nm), whereas the presence of ferrous ions Fe²⁺ (sometimes expressed as oxide FeO) causes a high absorption in the near infrared (absorption band centred on 1050 nm). The ferric ions Fe³⁺ give the glass a slight yellow colouration, whereas the ferrous ions Fe²⁺ give a pronounced blue-green colouration. Thus, the increase in the total iron content (in its two forms) accentuates the absorption in the visible to the detriment of the light transmission. Moreover, a high concentration of ferrous ions Fe²⁺ causes a decrease in the energy transmission. It is therefore also known in order to further increase the energy transmission of glass, to oxidise the iron present in the glass, i.e. to reduce the content of ferrous ions in favour of the content of ferric ions. The degree of oxidation of a glass is given by its redox, which is defined as the ratio of atomic weight of Fe²⁺ to the total weight of the iron atoms present in the glass: Fe²⁺ total Fe.

Several solutions have been proposed to reduce the redox of the glass.

For example, it is known to add cerium oxide (CeO₂) to glass. This is, however, very expensive and is likely to be a source of the phenomenon of “solarisation”, in which the transmission of the glass decreases significantly after absorbing ultraviolet rays.

It is also known to add antimony (in various forms) to glass. However, it is well known from the prior art, in particular from application WO 2009/047462 A1, that antimony is incompatible with the glass float process and to this day is used exclusively for glasses obtained using other techniques, in particular for cast and laminated glass. In fact, in the reductive conditions necessary for non-oxidation of the tin bath used in the float process, antimony vaporises, then condenses onto the glass sheet being formed, generating an undesirable surface colouration of the glass and thus causing a reduction in its transmission that is highly detrimental for extra clear types of glasses.

Moreover, patent applications WO 2007/106223 A1 and WO 2007/106226 A1 disclose glass compositions with a low iron content and high transmission devoid of antimony or in any case present in very low quantities (less than 100 ppm, preferably less than 50 ppm or even less than 5 ppm). According to these applications, the absence of antimony is highly recommended, since antimony is incompatible with the tin bath of the float process. The reduction of the redox in this case is obtained by adding sulphates into the batch of the raw materials. However, the addition of sulphates can cause the formation of foam in the melting furnace, which is known to cause quality problems in the produced glass.

Application WO 2006/121601 A1 describes mainly patterned glasses. These are typically obtained by casting the molten glass, which passes between two metal rollers spaced according to the desired thickness of the sheet and having patterns in the case where a patterned glass is desired. The glass of WO 2006/121601 A1 can contain from 100 (0.01%) to 10000 ppm by weight (1%) of antimony oxide Sb₂O₃ and preferably from 1000 to 3000 ppm by weight. Such high values of antimony oxide, in particular the preferred range of 1000 to 3000 ppm, cannot, of course, by used in a float process, since this would result in a float glass with a surface colouration that is unacceptable for solar applications and would not allow the transmission values indicated in application WO 2006/121601 A1 to be reached.

### 3. OBJECTIVES OF THE INVENTION

In particular, the objective of the invention is to remedy the disadvantages of the prior art, i.e. to provide a sheet of float glass with a high energy transmission.

More specifically, an objective of the invention in at least one of its embodiments is to provide a sheet of float glass with a high energy transmission in particular by means of an oxidation of the glass that is compatible with the float process, avoiding the phenomenon of solarisation and the formation of foam in the melting furnace.

Another objective of the invention is to provide a simple and economical solution to the disadvantages of the prior art.

### 4. OUTLINE OF THE INVENTION

In accordance with a particular embodiment the invention relates to a sheet of float glass having a composition consisting of the following, in a content expressed in percentages by total weight of glass:

| | |
|---|---|
| SiO₂ | 60-75% |
| Al₂O₃ | 0-10% |
| B₂O₃ | 0-5% |
| CaO | 0-15% |
| MgO | 0-10% |
| Na₂O | 5-20% |
| K₂O | 0-10% |
| BaO | 0-5% |
| total iron (expressed as Fe₂O₃) | 0.001 to 0.06%. |

According to the invention the composition has a content, expressed in percentage by total weight of glass, of 0.02 and 0.07% antimony (expressed as Sb₂O₃).

Thus, the invention is based on a completely novel and inventive approach, since it enables a solution to be given for the disadvantages of the prior art and the set technical problem to be resolved. In fact, the inventors have surprisingly demonstrated that by selecting the particular range of 0.02 to 0.07% by weight of antimony (expressed as Sb₂O₃), in association with the other composition criteria, an increase in the energy transmission of the sheet of float glass similar to that which can be observed in the case of a cast type laminated glass is obtained. In particular, the inventors have discovered that this precise limited range of antimony contents (expressed as Sb₂O₃) allowed a gain in energy transmission, since in this range antimony causes an increase in said transmission (due to its oxidising power) that is greater than the loss in transmission due to the phenomenon of surface colouration of float glass.

In the whole of the present text, when a numerical limit or a range is indicated, this includes the end limits. Moreover, all whole values and sub-ranges in numerical limits or a range are expressly included as if explicitly stated. Similarly, in the whole of the present text the percentage content values are values by weight expressed in relation to the total weight of the glass.

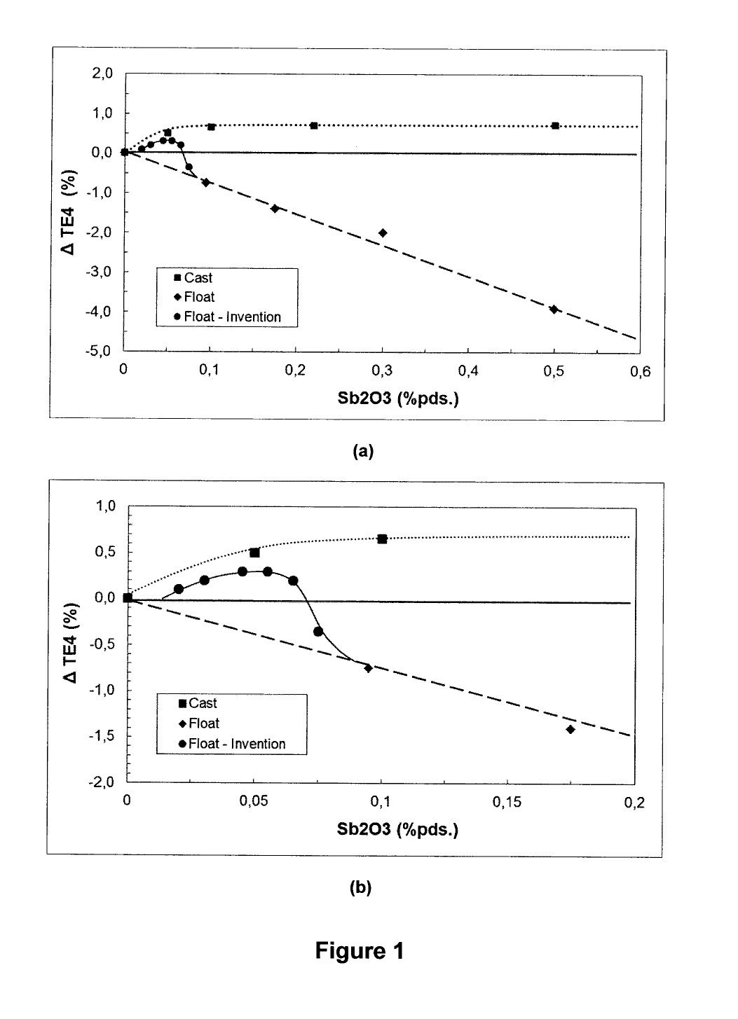

Other features and advantages of the invention will become clearer on reading the following description of a preferred embodiment given by way of non-restrictive example and of FIG. 1, which shows the effect of the addition of antimony on the energy transmission of a sheet of cast type glass according to the prior art and of a sheet of float glass.

### 5. DESCRIPTION OF AN EMBODIMENT OF THE INVENTION

The glass sheet according to the invention is a sheet of float glass. A sheet of float glass is understood to be a glass sheet formed by the float process that consists of pouring the molten glass onto a molten tin bath in reductive conditions. In a known manner, a sheet of float glass comprises a so-called “tin face”, i.e. a face enriched with tin in the bulk of the glass close to the surface of the sheet. Tin enrichment is understood to be an increase in the concentration of tin in relation to the core composition of the glass which can be substantially zero (devoid of tin) or not.

According to an embodiment of the invention the tin concentration from the surface of the glass is distributed into the bulk of the glass according to a profile, which progresses towards zero or towards a constant value identical to the concentration present in the core of the glass from a surface depth ranging between 10 and 100 microns. According to this embodiment of the invention the profile of tin concentration can decrease continuously and monotonically from the surface of the glass or it can exhibit a maximum peak.

According to an embodiment of the invention the composition comprises a content, expressed in percentage by total weight of glass, of 0.03 to 0.06% antimony (expressed as Sb₂O₃). In such a range of antimony contents there is a greater increase in the energy transmission of the sheet of float glass.

According to the invention the composition comprises a total iron content (expressed as Fe₂O₃) of 0.001 to 0.06% by weight in relation to the total weight of the glass. A total iron content (expressed as Fe₂O₃) of more than or equal to 0.001% by weight in relation to the total weight of the glass means that the cost of the glass will not be jeopardised too greatly, since such low values often require very pure costly raw materials or even a purification thereof. A total iron content (expressed as Fe₂O₃) of less than or equal to 0.06% by weight in relation to the total weight of the glass enables the optical transmission (in particular light transmission) of the glass sheet to be increased. The total iron content (expressed as Fe₂O₃) is preferably 0.001 to 0.02% by weight in relation to the total weight of the glass. A total iron content (expressed as Fe₂O₃) of less than or equal to 0.02% by weight in relation to the total weight of the glass enables the energy transmission of the glass sheet to be further increased.

According to an advantageous embodiment of the invention the composition has a redox of 0.01 to 0.4. This redox range enables highly satisfactory optical properties to be obtained in particular in terms of energy transmission. The composition preferably has a redox of 0.1 to 0.3. Most preferred, the composition has a redox of 0.1 to 0.25.

According to the invention, in addition to the impurities contained in the raw materials in particular, the composition of the sheet of float glass can contain a low proportion of additives (such as agents that assist the melting or refining of the glass) or of elements resulting from the dissolution of refractories forming the melting furnaces.

The composition of the sheet of float glass is preferably free from arsenic (often expressed in the form of oxide As₂O₃), which is a highly toxic oxidising agent. The term “free” is understood to mean that the composition comprises a maximum arsenic content (expressed as As₂O₃) that is in the order of 10 ppm (1 ppm=0.0001%).

For other reasons discussed above (prevention of the phenomenon of solarisation), the composition of the sheet of float glass is preferably free from cerium (often expressed in the form of oxide CeO₂). The term “free” is understood to mean that the composition comprises a maximum cerium content (expressed as CeO₂) that is in the order of 30 ppm.

It is most preferred if the composition of the sheet of float glass is free both of arsenic and of cerium.

The composition of the sheet of float glass preferably does not contain any colouring agent other than iron such as, for example, selenium, copper and oxides of cobalt, copper, chromium, neodymium. These colouring agents would in fact cause a detrimental colouration in the composition of the invention. Moreover, their colouring effect often shows with low contents in the order of few ppm or less for some. Their presence would thus greatly reduce the optical transmission of the glass sheet. Nevertheless, it can happen that extra clear glass exhibits traces of some of these colouring elements due to contaminations or the use of certain less expensive raw materials. However, for some applications it can be advantageous to add cobalt oxide in a content of less than 1 ppm to provide a slight blue colouration at the cut edge of the glass sheet.

The sheet of float glass according to the invention preferably has an energy transmission measured for a thickness of 4 mm (ET4) of at least 89%. Advantageously, the sheet of float glass according to the invention has an energy transmission measured for a thickness of 4 mm (ET4) of at least 90% and better still at least 91%.

The sheet of float glass according to the invention preferably has a light transmission measured with illuminant D65 according to standard ISO 9050 and for a thickness of 4 mm (LTD4) of at least 90.5%.

In the case of a solar photovoltaic module the sheet of float glass according to the invention preferably forms the protective substrate (or cover) of photovoltaic cells.

According to an embodiment of the invention the sheet of float glass is coated with at least one thin transparent and electrically conductive layer. This embodiment is advantageous for photovoltaic applications. When the glass is used as protective substrate for a photovoltaic module, the thin transparent and conductive layer is arranged on the inside face, i.e. between the glass sheet and the solar cells.

A thin transparent and conductive layer according to the invention can be, for example, a layer based on SnO₂:F, SnO₂:Sb or ITO (indium tin oxide), ZnO:Al or also ZnO:Ga.

According to another advantageous embodiment of the invention the sheet of float glass is coated with at least one antireflective (or antiglare) layer. This embodiment is advantageous in the case of photovoltaic applications in order to maximise the energy transmission of the glass sheet and, for example, to thus increase the efficiency of the solar module comprising this sheet as substrate (or cover) covering the photovoltaic cells. In applications in the solar field (photovoltaic or thermal), when the glass sheet is used as protective substrate, the antireflective layer is arranged on the outside face, i.e. on the insolation side.

An antireflective layer according to the invention can be, for example, a layer based on porous silica having a low refractive index or it can be formed from several layers (lamination), in particular a lamination of layers of dielectric material alternating layers of low and high refractive index and terminating with a layer of low refractive index.

According to an embodiment the sheet of float glass is coated with at least one thin transparent and electrically conductive layer on a first face and at least one antireflective layer on the other face.

According to another embodiment the sheet of float glass is coated with at least one antireflective layer on each of its faces.

According to another embodiment the sheet of float glass is coated with at least one antifouling layer. Such an antifouling layer can be combined with a thin transparent and electrically conductive layer arranged on the opposing face. Such an antifouling layer can also be combined with an antireflective layer arranged on the same face, wherein the antifouling layer is on the outside of the lamination and thus covers the antireflective layer.

According to a further embodiment the sheet of float glass is coated with at least one mirror layer. Such a mirror layer is, for example, a silver-based layer. This embodiment is advantageous in the case of solar mirror applications (plane or parabolic mirrors).

Depending on the applications and/or the properties desired, other layers can be arranged on one face or the other of the sheet of float glass according to the invention.

The sheet of float glass according to the invention can have a thickness of 0.5 to 15 mm. It can be integrated into a multiple glazing unit (in particular double or triple glazing). Multiple glazing is understood to be a glazing unit that comprises at least two glass sheets with a space filled with gas arranged between each couple of sheets. The glass sheet according to the invention can also be laminated and/or toughened and/or hardened and/or bent.

The invention also relates to a solar photovoltaic module or a mirror for the concentration of solar energy comprising at least one sheet of float glass according to the invention.

The following examples illustrate the invention without any intention of limiting its coverage in any way.

### EXAMPLES

The following examples are intended to compare the gain/loss of energy transmission obtained by the addition of a certain antimony content for glasses formed in the laboratory by a casting type process (melting with reductive atmosphere) and by a float type process (melting followed by a period at high temperature in a reductive atmosphere). The float process conducted in the laboratory reproduces as faithfully as possible the reductive atmosphere (5% H₂+95% N₂) and the temperature profile that a melting glass can be subjected to during its formation by a float process.

The raw materials have been mixed in powder form and have been placed in a crucible for melting without reductive atmosphere.

The tested glasses all have the composition indicated below except for the quantity of antimony that varies from one glass to another. The antimony content expressed in the form of Sb₂O₃ has been fixed at the following values in percentage by total weight of the glass from one sample to another: 0; 0.02; 0.03; 0.045; 0.055; 0.065; 0.075; 0.095; 0.1; 0.175; 0.22; 0.3 and 0.5%.

| Compound | Content [% by weight] |
|---|---|
| CaO | 9 |
| K₂O | 0.015 |
| Na₂O | 14 |
| Fe₂O₃ | 0.01 |
| SO₃ | 0.3 |
| TiO₂ | 0.015 |
| Al₂O₃ | 0.7 |
| MgO | 4.5 |
| Sb₂O₃ | variable (from 0 to 0.5%) |

After this first melt without reductive atmosphere, the samples obtained typically correspond to glasses obtained by a casting type process. The optical properties of each glass sample with the composition type and a certain content of Sb₂O₃ have been determined and, in particular, the energy transmission was measured in accordance with standard ISO 9050 (ET).

The samples are then placed in a furnace in a reductive atmosphere (95% N₂+5% H₂) at 180° C. and heated to 950° C. for 10 minutes. The samples are then cooled to 600° C. for 8 minutes. They are then removed from the furnace and gradually cooled to ambient temperature in an annealing furnace in ambient atmosphere.

The samples obtained after this test procedure in the laboratory typically correspond to glasses obtained by a float type process. The optical properties of these glass samples were finally determined and, in particular, the energy transmission was measured according to standard ISO 9050 (ET).

The ET values for a thickness of 4 mm were compared between cast type glasses and float type glasses to verify whether the gain in energy transmission due to the oxidising effect of antimony oxide is greater than the loss in transmission due to the colouration caused by the antimony after treatment in reductive conditions.

FIG. 1 (a) shows the difference (ΔET4) between the energy transmission of each of the samples of antimony-based glass and that of a glass sample without antimony (0% by wt. Sb₂O₃) using the two aforementioned types of production. FIG. 1 (b) is an expansion of FIG. 1 (a).

Consequently, this FIGURE shows that, while the energy transmission of the cast type glass increases with the antimony content whatever this content, this is not the case with a float type glass. In fact, a gain in energy transmission is only observed in the range of 0.02 to 0.07% by weight of Sb₂O₃. Larger concentrations of antimony cause significant undesirable colouration and loss of transmission, whereas lower concentrations in antimony are ineffective in significantly increasing the energy transmission.

Hence, the antimony content in the claimed range allows an increase in energy transmission that can reach 0.3%, which is significant in the solar field.

1. A sheet of float glass having a composition comprising, in a content expressed in percentages by total weight of glass:

| | |
|---|---|
| SiO₂ | 60-75%; |
| Al₂O₃ | 0-10%; |
| B₂O₃ | 0-5%; |
| CaO | 0-15%; |
| MgO | 0-10%; |
| Na₂O | 5-20%; |
| K₂O | 0-10%; |
| BaO | 0-5%; and |
| total iron (expressed as Fe₂O₃) | 0.001 to 0.06%, |

wherein the composition has a content expressed in percentage by total weight of glass of from 0.02 to 0.07% by weight of antimony (expressed as Sb₂O₃).

2. The sheet of claim 1, wherein the composition has a content expressed in percentage by total weight of glass of from 0.03 to 0.06% by weight of antimony (expressed as Sb₂O₃).

3. The sheet of claim 1, wherein the composition has a content expressed in percentages by total weight of glass of from 0.001 to 0.02% by weight of total iron (expressed as Fe₂O₃).

4. The sheet of claim 1, wherein the composition has a redox of from 0.01 to 0.4.

5. The sheet of claim 1, wherein the composition has a redox of from 0.1 to 0.3.

6. The sheet of claim 1, wherein the composition is free from cerium.

7. The sheet of claim 1, wherein the composition is free from arsenic.

8. The sheet of claim 1, it wherein the sheet has an energy transmission measured for a thickness of 4 mm (ET4) of at least 89%.

9. The sheet of claim 1, it wherein the sheet has an energy transmission measured for a thickness of 4 mm (ET4) of at least 90%.

10. The sheet of claim 1, wherein the sheet has an energy transmission measured for a thickness of 4 mm (ET4) of at least 91%.

11. The sheet of claim 1, wherein the sheet is coated with a thin transparent and electrically conductive layer.

12. The sheet of claim 1, wherein the sheet is coated with an antifouling layer.

13. The sheet of claim 1, wherein the sheet is coated with an antireflective layer.

14. The sheet of claim 1, wherein the sheet is coated with a mirror layer.

15. A solar photovoltaic module or mirror, comprising the sheet of float glass of claim 1.
